(19) United States
(12) Patent Application Publication
(10) Pub. No.: US 2021/0377018 A1
(43) Pub. Date: Dec. 2, 2021

(54) SECURE REMOTE ACCESS TO INDUSTRIAL CONTROL SYSTEMS USING HARDWARE BASED AUTHENTICATION

(71) Applicant: Electric Power Research Institute, Inc., Palo Alto, CA (US)

(72) Inventors: Jeremy Lawrence, Huntersville, NC (US); Jason M. Hollern, Harrisburg, NC (US); Bradley Geddes, Carbondale, CO (US); Michael L. Thow, Concord, NC (US); Justin C. Thibault, Concord, NC (US)

(21) Appl. No.: 16/888,063

(22) Filed: May 29, 2020

(51) Int. Cl. H04L 9/08; G05B 19/418; H04L 9/32

(52) U.S. Cl. CPC H04L 9/0894; G05B 19/41835; G05B 2219/31457; H04L 9/3249; H04L 9/3263

(57) ABSTRACT

A system and method for secure remote access to an industrial control system using hardware based authentication is provided, comprising secure user authentication, secure interactive remote access or secure machine-to-machine remote access or communication, and remote access services. Secure user authentication comprises two-factor authentication based on smart cards, and secure interactive remote access via a managed remote-access appliance comprises a virtual machine and software that can only be used with a smart card credential.

### BACKGROUND

There is a growing need for remote access to industrial control systems by employees and vendors in order to perform monitoring, troubleshooting, and maintenance. As critical control networks grow more digitized and interconnected, there is a need for secure remote access to reduce the risk of a cyber attack pathway for critical industrial control networks such as those of power utilities.

### SUMMARY

Provided is a system for secure remote access to an industrial control system, such as that of electrical power utilities, using hardware based authentication, comprising secure user authentication; secure interactive remote access or secure machine-to-machine remote access or communication; and remote access services.

Also provided is a method for secure remote access to an industrial control system, comprising the steps of: providing a system for secure remote access to an industrial control system using hardware based authentication; performing secure user authentication; providing secure interactive remote access or secure machine-to-machine remote access or communication; and providing remote access services.

### BRIEF DESCRIPTION OF THE DRAWINGS

FIG. 1 is a general diagram of the system for secure remote access to an industrial control system.

FIG. 2 is an end-user authorization flow diagram for the system for secure remote access to an industrial control system.

### DETAILED DESCRIPTION

Provided is a system and method for secure remote access to an industrial control system using hardware based authentication, comprising secure user authentication, secure interactive remote access or secure machine-to-machine remote access or communication, and remote access services.

Secure user authentication is provided through secure two-factor authentication (2FA) or secure three-factor authentication (3FA) based on smart cards in a plastic identity card form factor with contact and contactless interface. Possession of the smart card and knowledge of the corresponding personal identification number (PIN) is required for two-factor secure user authentication. Three-factor authentication also implements biometrics, verification of a biological trait which may include but is not limited to retina scans, iris scans, fingerprint scans, finger vein scans, facial recognition, voice recognition, hand geometry, and earlobe geometry. This authentication enables a multistep verification with respect to session approval via third party verification. An additional factor, location, may be employed for four-factor authentication (4FA). Distributed keys and credentials secured within smart card hardware provide secure key management and storage, and enable NIST IAL 3 and AAL3 levels of identity proofing and authentication according to guidelines provided by NIST Special Publication 800-63-3 from the National Institute of Standards and Technology. An example of an appropriate smart card is a SideCard™ from Tyfone, Inc.

Secure interactive remote access may be provided through a secure hardened, stateless software appliance. A managed Remote-Access Appliance (RAA), comprising a virtual machine and software, is used to initiate the remote access to an industrial plant uniformly from any remote access workstation, which may be dedicated, managed or unmanaged. The underlying virtual machine of the appliance provides the controlled environment that can be managed by policy, even when invoked from an unmanaged workstation. The appliance can only be used with a smart card credential. The local authentication credential to the appliance is separated from the certificate based remote access authentication to the plant network, both of which are stored in the smart card. Secure interactive remote access may be provided through secure machine-to-machine remote access or communication.

Remote access services may include, but are not limited to, technical cyber-security control services that automate security policy and processes for user and token lifecycle management, software configuration management, access control and authorization using layered security, and audit trails of remote access. Layered security may provide for more than one individual to be involved in authorizing scheduled and unscheduled remote access to an industrial plant, and audit logs provide additional levels of control in the security policy of a plant that wishes to enable secure remote access to the plant infrastructure.

The smart card may comprise hardware endpoint security technology, and comprises ISO7816 Contact and ISO14443A Contactless interfaces, and a Bluetooth (BLE) interface, providing the flexibility to be used for omnichannel security for physical as well as all digital transactions across mobile and non-mobile devices. Platform agonistic low-level interface specifications and platform specific high-level API library are available for the smart card, which optionally interoperates with a digital security platform for identity and transactions, providing layered step-up security that supports all NIST levels of assurance, including the highest levels in the industry, while not compromising convenience and user experience. The smart card allows an organization to implement decentralized and distributed user authentication in a convenient, familiar form factor, providing strong authentication and increased safeguards, and significantly reducing cybersecurity risks and operational costs.

The smart card secure element (SE) provides the highest levels of built-in tamper resistance, secure storage and hardware encryption. The secure element allows storing of credentials, cryptographic keys, and X.509 certificates, making it non-extractable by hackers. The secure element stores the PIN and the RSA 2048-bit private key with the associated X.509 certificate. The PIN resides in the secure element's electrically erasable programmable read-only memory (EEPROM) as a PIN object and it is not extractable. The PIN cannot be stolen. The PIN can be changed if the older PIN is known. The private key resides in the secure element's EEPROM as a PrivateKey object and it is not extractable. The private key can be deleted, and a new one can be created if the PIN is known. The private key cannot be stolen. The secure element is NIST FIPS 140-2 certified and is tamper proof. The private key is used to sign transactions. Access to the secure element in the smart card is granted only after successful authentication using the PIN. The maximum number of incorrect PIN entries is limited. If the maximum number of PIN entries exceeds the set value, then the card is blocked and will have to be re-provisioned to the user by the administrator, such as by using a personalization kiosk.

Three types of smart cards may be provided according to the role of the individual with respect to the system, including one type for an administrator, one type for a supervisor, and one type for a remote user. All three types of cards are provisioned with client user certificates, generated on the secure element. The smart cards may communicate with other devices using a contact interface such as a smart card reader, or a contactless interface such as Bluetooth (BLE) or radio frequency identification (RFID).

Remote access services allow for management of the users, smart card tokens, and appliance (virtual machine and software) state, as well as remote access authorizations and policy, and layered-security controls. Remote access services implement technical cyber-security controls for managing and auditing interactive remote access. A mobile application for the supervisor implements layered-security controls for remote access authorization and access control, and two-factor authentication using smart cards is implemented on the mobile device. A mobile tablet application for the administrator implements layered-security controls for remote access authorization and access control, and two-factor authentication using smart cards is implemented on the mobile tablet device.

Remote access services are responsible for storing user-plant information and verification of access requests, with data exchange via a mutually authenticated Transport Layer Security (TLS) channel, and are also responsible for technical cyber-security control services. Security controls are according to the guidelines in the NIST SP800-53 rev 4 document from the National Institute of Standards and Technology. Technical cyber-security control services may include, but are not limited to, account management, access control, information flow enforcements, control of unsuccessful login attempts, system use notification, concurrent session control, session termination, permitted actions without identification or authentication, security attributes and transmission, remote access, auditable events, audit records and storage capacity, audit review and analysis, audit reporting, time stamps, non-repudiation, identification and authentication, denial of service protection, transmission integrity and confidentiality, use of cryptography, public key infrastructure certificates, protection of information at rest, virtualization techniques, malicious code protection, control of software and information integrity, information input restrictions, and protection against malware.

The account management system may comprise three types of roles, an administrator, a supervisor, and at least one end-user. An administrator can create, modify, or delete other administrators, supervisors or end-users. The administrator can also create access schedules for end-users that have to be authorized by the supervisor. The supervisor has the privilege to grant or deny access to a workstation for a user. The end-user can have scheduled or unscheduled access to a workstation. The identity of the individual is established using a smart card that is protected by a localized PIN. For access control, an administrator has access to set up plants, users, workstations and associate users to plants and workstations. The administrator also has access to a provisioning tool, which is used to create users and provision smart cards to users. The supervisor can access authorization requests via the supervisor application, and has the privilege to grant or deny scheduled or unscheduled access requests. The end-user can access a workstation if an access is scheduled or can request for an unscheduled access. The end-user cannot access the administrator and supervisor tools. The supervisor cannot access the administrator and end-user tools.

Certain actions may be permitted without identification or authentication. The supervisor and administrator applications allow the user of the applications to view notifications. However, no action can be performed on the notification until the user is authenticated using the smart card and the PIN. A session is created after a successful login, and terminated after a logout. Multiple concurrent sessions may be allowed. System use notifications are sent to the supervisor informing the supervisor of end-user login, logout and workstation access of the end-user. For unsuccessful login attempts, the access to the private key in the secure element of the smart card is protected by the PIN. If the PIN entered is incorrect then the user is asked to enter the PIN again. The maximum number of incorrect PIN entries is limited. If the maximum number of PIN entries exceeds the set value, then the card is blocked. The smart card will have to be re-provisioned to the user by the administrator such as by using the personalization kiosk.

Remote access to a workstation can be scheduled or unscheduled. However, prior authorization by the supervisor is required to access the workstation. Auditable events and content of audit records include all transaction events that are stored securely in a database, with a storage capacity that is limited only by the size allotted to the database server. Time stamps are stored according to coordinated universal time (UTC). Non-repudiation is achieved by using the RSA cryptosystem digital signature scheme, and the transaction information is stored in the database for auditing. For identification and authentication, during provisioning the administrator verifies the physical identification of the individual before assigning a smart card to the user. During authentication, the user has to provide a PIN to the smart card. The authentication happens over a mutually authenticated TLS channel where the user certificate and the server certificate are validated.

In certain embodiments, cryptographic standards are used according to Federal Information Processing Publication 140-2 (FIPS 140-2), titled “Security Requirements For Cryptographic Modules”. For public key infrastructure certificates, a valid certificate authority (CA) should provide user certificates. RSA (2048 bit key) X.509 certificates are used as user certificates. Virtualization techniques involve the remote access appliance (RAA) which runs in kiosk mode. Malicious code protection is accomplished through an application integrity check. Information input restrictions are designed for the input of sensitive data using the randomized software PIN pad. This protects the system against keylogging and screen scraping.

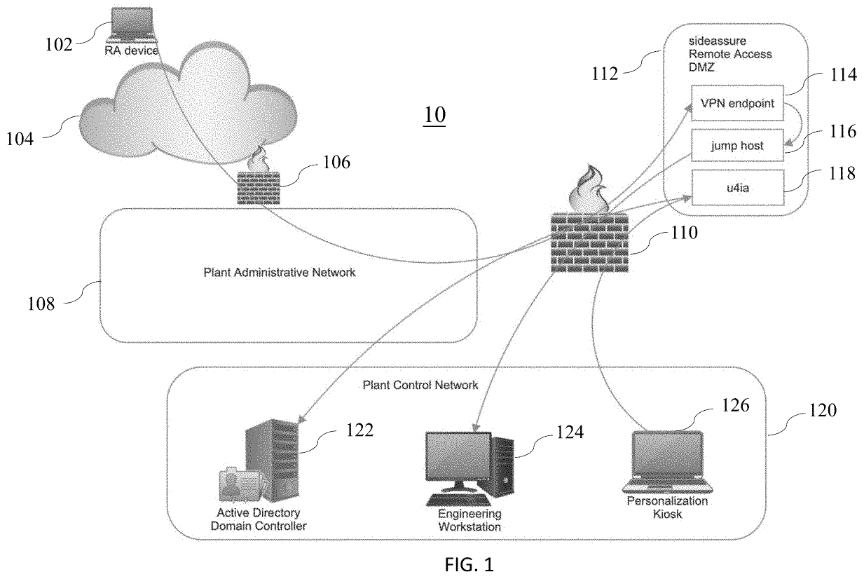

A simple high-level architectural illustration of an embodiment of the secure remote access to an industrial control system of a single plant network is shown in FIG. 1. This diagram provides a broad overview of the system, with key elements and data flows. The system provides a secure, decentralized, and auditable approach to remote access in a way that should not interfere with existing software technologies, such as session monitoring software and legacy remote access. The illustration is for one industrial plant, but the underlying architecture may also be used for multiple industrial plants. In a multiple plant deployment embodiment, the u4ia digital security platform would be federated among all of the plants and each plant would also have its own stand-alone u4ia instance for fault tolerance.

According to certain illustrative embodiments, the key elements of the secure remote access to an industrial control system 10 in FIG. 1 include a Remote Access (RA) device 102 which is a laptop configured with appropriate software, communicating over the internet with cloud computing 104; a Remote Access physical or logical perimeter network or screened subnetwork known in computer security as a demilitarized zone (DMZ) 112, such as a collection of servers and software such as that provided by SideAssure from Tyfone, Inc.; and a Plant Control Network 120. The Remote Access DMZ 112 comprises a secure virtual private network (VPN) terminus endpoint 114, a secure jump-host 116, and a u4ia server 118 authentication appliance. The Plant Control Network 120 comprises a Personalization Kiosk 126, a laptop configured with software used to issue and manage SideCard devices; at least one Engineering Workstation 124, a target computer in the client network to which remote access is being provided; and a Windows Active Directory Domain Controller 122 which mediates logon and policy access for users and machines in the plant control network. In this illustration, the Engineering Workstation is an example of a control system component. In other embodiments, the control system component may include, but is not limited to, a security workstation, human machine interface (HMI), a supervisory workstation, a log server, a historian, or any control system component capable of utilizing a group policy structure. It may also be any incident command system (ICS) component for machine-to-machine communication which may include, but is not limited to, programmable logic controller (PLC) to human machine interface (HMI) or PLC to PLC communication.

In illustrative embodiments, internet access 104 with adequate bandwidth and latency characteristics enters into the plant administrative network 108 through a firewall 106, from the Remote Access (RA) device 102. The plant administrative network 108 may be connected to the Remote Access DMZ 112 network either via a direct connection or via a firewall gateway 110. If via a firewall gateway, the rules should be set as required to allow the necessary ingress and egress to the Remote Access DMZ 112. The Remote Access DMZ 112 may be connected to the plant control network via a firewall gateway 110, on which rules are set to allow ingress and egress from the DMZ to specific Engineering Workstations 124 as required. Plant operators will generally retain control of all firewalls and network monitoring, as ultimate responsibility for plant network security will lie with the plant operators. The plant control network 120 is isolated from other networks, and in particular does not include a path to the internet for either inbound or outbound traffic.

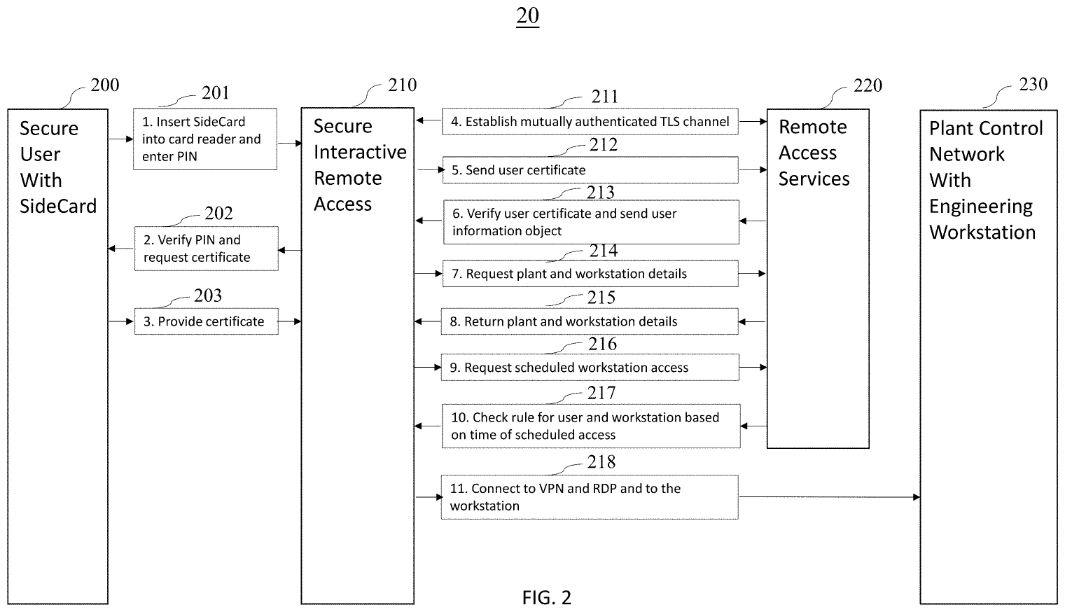

An end-user authorization flow diagram for the system and method for secure remote access to an industrial control system 20 is shown in FIG. 2 for a scheduled user access to a workstation. According to this illustrative embodiment, the system for secure remote access to an industrial control system using hardware based authentication comprises secure user authentication originating with a secure user with a SideCard 200, secure interactive remote access 210, and remote access services 220.

For step 1, the secure user with SideCard 200 inserts the smart card (SideCard) into a card reader and enters a PIN 201. The remote access appliance (RAA) virtual machine for secure interactive remote access 210 is opened, and in step 2 verifies the PIN and requests the certificate 202. For step 3, the smart card provides the user certificate 203 to the remote access appliance of secure interactive remote access 210. Using the user's certificate and the remote access services (RAS) 220 certificate, in step 4 a mutually authenticated TLS channel is established 211. The remote access services 220 comprises a server that includes plant information and u4ia digital security platform.

In step 5, the secure interactive remote access appliance (RAA) 210 sends the user certificate 212 to the remote access services (RAS) 220. In step 6, the remote access services 220 verifies the user certificate and sends user information object 213 to secure interactive remote access 210. In step 7, the secure interactive remote access 210 sends a request to the remote access services 220 to request plant and workstation details 214. In step 8, the remote access services 220 sends plant and workstations details 215 to the secure interactive remote access 210. In step 9, the secure interactive remote access 210 sends a scheduled workstation access request 216 to the remote access services 220. In step 10, the remote access services 220 checks the rule associated with the end-user and the workstation based on the time of access and determines that it is a scheduled access 217.

A scheduled request does not require authorization from the plant supervisor. In step 11, the secure interactive remote access 210 will connect to the virtual private network (VPN) and then to the remote desktop protocol (RDP) gateway and finally to the engineering workstation 218 in the plant control network 230. If the request was unscheduled, then the access to a workstation would have required the authorization of a plant supervisor.

The provided system and method for secure remote access to an industrial control system using hardware based authentication, comprising secure user authentication, secure interactive remote access or secure machine-to-machine remote access or communication, and remote access services, implements a number of important advantageous attributes. Distributed secure element physical tokens connected via either contact or contactless interfaces prevent bulk theft and remote credential harvesting, and allow for loss awareness so that a lost or stolen access card will be easily detected by a user. Strong encryption and the highest level of NIST 800-63 Authenticator Assurance Level (AAL)—Level 3 are enabled, layering defenses by routing traffic through multiple check points where asymmetric (NIST LOA3) strong cryptographic authentication is required.

The provided system and method for secure remote access to an industrial control system is a holistic solution, implementing industry best practices in a complete solution for control systems, and mitigating the possibility of a compromised host (user device) by utilizing a stateless guest operating system, verification of guest integrity, and hardened guest operating systems. Access control lists are used to filter inbound traffic and limit outbound traffic, and access control is independently authorized on a session-by-session basis, either scheduled or ad-hoc. The network is monitored, logging traffic and auditing traffic flows. Capabilities also include remote desktop protocol (RDP) shadowing, and forced session termination. The provided system and method for secure remote access utilizes a virtual private network (VPN) and is easily integrated with existing architecture.

### EXAMPLE

By way of illustration, and without limitation, an example of the provided system and method for secure remote access to an industrial control system using hardware based authentication may comprise the following 40 component steps of secure user authentication, secure interactive remote access or secure machine-to-machine remote access or communication, and remote access services:
1. The end-user inserts the user's smart card into a card reader where the remote access appliance (RAA) virtual machine is opened. This is a Windows kiosk virtual machine used by the end-user to access a workstation in a plant.
2. The user enters the smart card personal identification number (PIN) and the remote access appliance sends the ‘verify PIN’ request to the smart card.
3. The smart card verifies the user PIN.
4. If the PIN entered is incorrect then the user is asked to enter the PIN again. The maximum number of incorrect PIN entries is limited. If the maximum number of PIN entries exceeds the set value, then the card is blocked and the smart card will have to be re-provisioned to the user by the administrator using the personalization kiosk.
5. If the PIN entered is correct, then the remote access appliance asks for the user certificate details from the smart card.
6. The smart card provides the user certificate to the remote access appliance. Note that the certificate has information only about the public key.
7. Using the user's certificate and the remote access service (RAS) certificate, a mutually authenticated TLS channel is established. The remote access service is a server that includes plant information and u4ia digital security platform.
8. The remote access appliance (RAA) sends the user certificate to the remote access service (RAS).
9. The remote access service verifies the user certificate using the issuer certificate.
10. If the user certificate is valid, then the user-information is sent to the remote access appliance.
11. The remote access appliance sends a request to the remote access service to get information about the plants and workstations.
12. The remote access service sends plants and workstations information to the remote access appliance.
13. The end-user will choose the workstation for which access is required. The remote access appliance sends this request to the remote access service.
14. The remote access service checks the policy associated with the end-user and the workstation based on the time of access and decides whether it is an unscheduled access or if it is a scheduled access.
15. A scheduled request does not require authorization from the plant supervisor. The remote access appliance will connect to the virtual private network (VPN) and then to the remote desktop protocol (RDP) gateway and finally to the workstation. Access to virtual private network, remote desktop protocol gateway and the workstation requires the smart card. The user PIN is entered automatically by the remote access appliance.
16. In case of an unscheduled request, the access to a workstation requires the authorization of the plant supervisor. The remote access appliance shall start polling the remote access service for the status for the access request.
17. The remote access service recognizes the supervisors associated with the plant.
18. The remote access service will send push notifications to the supervisors of a plant with the access request details and a challenge.
19. The remote access service creates a digital receipt of the access request.
20. The supervisor will click on the notification.
21. The supervisor application is opened, and the supervisor is asked to enter the Token Serial Number (TSN) of the card. Note that the TSN is automatically filled in if the smart card was already paired with the supervisor's mobile device. The supervisor application is a mobile application that is used to authorize access to a workstation in a plant.
22. The supervisor turns on the smart card.
23. The supervisor's device connects to the smart card using a Bluetooth (BLE) connection.
24. The supervisor application will initialize the group identifiers (GIDS) applet in the smart card.
25. The supervisor enters the PIN.
26. The supervisor application sends the verify PIN request to the smart card.
27. If the PIN entered is incorrect then the user is asked to enter the PIN again. The maximum number of incorrect PIN entries is limited. If the maximum number of PIN entries exceeds the set value, then the card is blocked and the smart card will have to be re-provisioned to the user by the administrator using a personalization kiosk.
28. If the PIN entered is correct, then the supervisor application asks for the user certificate details from the smart card.
29. The smart card provides the user certificate to the supervisor application. Note that the certificate has information only about the public key.
30. Using the supervisor's certificate and the remote access service certificate a mutually authenticated TLS channel is established between the supervisor application and the remote access service.
31. The supervisor application gets the transaction details from the notification.
32. For additional data regarding the transaction the supervisor application gets it from the remote access service.
33. Note that the supervisor application will have to sign the transaction irrespective of whether the supervisor chooses to Accept or Reject the access request. The transaction information and the challenge to be signed is hashed using secure hash algorithm 256-bit (sha256) and sent to the smart card for a digital signature.
34. The smart card signs the hashed transaction and challenge using RSA 2048 bit private key and sends it to the supervisor.
35. The supervisor application sends the signature to remote access service for verification.
36. The remote access service uses the digital receipt (to get transaction information and challenge) to verify the digital signature.
37. If the verification is successful, then a success message is sent to the supervisor application.
38. If the verification is unsuccessful, then an error message is sent to the supervisor application.
39. The verification result is updated in the digital receipt and persisted for auditing and reporting purposes.
40. The remote access appliance that is polling the remote access service for the status of the access request can get the following response:
   APPROVED: This indicates that the access request for the workstation access has been approved by the supervisor.
   PENDING: This indicates that the access request for the workstation access has not yet been approved by the supervisor.
   REJECTED: The supervisor has rejected the access request.
   EXPIRED: The access request has expired.
   FAILURE: Failed verification.

Therefore, in a first embodiment there is provided a system for secure remote access to an industrial control system using hardware based authentication, comprising:

secure user authentication;

secure interactive remote access or secure machine-to-machine remote access or communication; and

remote access services.

According to the first embodiment, the secure user authentication comprises two-factor authentication (2FA) or three-factor authentication (3FA) based on smart cards. According to the first and subsequent embodiments, the secure user authentication may comprise possession of a smart card and knowledge of the corresponding personal identification number (PIN) and, optionally, biometrics. According to the first embodiment and subsequent embodiments, the smart cards comprise secure element (SE) storing of credentials, cryptographic keys, and X.509 certificates. Also according to the first and subsequent embodiments, the smart cards for an administrator, a supervisor, and an end-user have different capabilities.

According to the first embodiment and subsequent embodiments, the secure interactive remote access comprises a managed remote-access appliance (RAA), comprising a virtual machine and software. According to the first embodiment and subsequent embodiments, the managed remote-access appliance (RAA) may only be used with a smart card credential.

According to the first embodiment and subsequent embodiments, the remote access services comprise technical cyber-security control services that automate security policy and processes for user and token lifecycle management, software configuration management, access control and authorization using layered security, and audit trails of remote access. According to the first embodiment and subsequent embodiments, the remote access services may comprise management of users, smart card tokens, remote-access appliance (RAA) state, remote access authorizations and policy, and layered-security controls.

In a second embodiment there is provided a method for secure remote access to an industrial control system, comprising the steps of:

providing a system for secure remote access to an industrial control system using hardware based authentication;

performing secure user authentication;

providing secure interactive remote access or secure machine-to-machine remote access or communication; and

providing remote access services.

According to the second embodiment, the step of performing secure user authentication comprises providing two-factor authentication (2FA) or three-factor authentication (3FA) requiring possession of a smart card and a personal identification number (PIN) and, optionally, biometrics. According to the second embodiment and subsequent embodiments, the step of providing secure interactive remote access may comprise authorizing a smart card PIN with a remote access appliance (RAA) comprising a virtual machine and software.

According to the second embodiment and subsequent embodiments, the step of providing remote access services comprises providing account management of the roles of an administrator, a supervisor, and at least one end-user. According to the second embodiment and subsequent embodiments, the step of providing remote access services may comprise providing non-repudiation by using the RSA cryptosystem digital signature scheme. According to the second embodiment and subsequent embodiments, the step of providing remote access services may comprise providing auditable records by securely storing all transaction events in a database.

According to the second embodiment and subsequent embodiments, the step of providing remote access services comprises limiting the number of incorrect PIN entries. According to the second embodiment and subsequent embodiments, the step of providing remote access services may comprise sending system use notifications to a supervisor informing the supervisor of end-user login, logout and workstation access of the end-user.

According to the second embodiment and subsequent embodiments, the step of providing remote access services may comprise providing identification and authorization processes. According to the second embodiment and subsequent embodiments, the step of providing remote access services may comprise requiring a supervisor to authorize user access to a workstation.

While the system and method for secure remote access to an industrial control system using hardware based authentication, comprising secure user authentication, secure interactive remote access or secure machine-to-machine remote access or communication, and remote access services have been described in connection with various illustrative embodiments, it will be understood that the embodiments described herein are merely exemplary, and that one skilled in the art may make variations and modifications without departing from the spirit and scope of the embodiments. All such variations and modifications are intended to be included within the scope of the embodiments as described hereinabove.

Further, all embodiments disclosed are not necessarily in the alternative, as various embodiments may be combined to provide the desired result. Therefore, the system and method for secure remote access to an industrial control system using hardware based authentication, comprising secure user authentication, secure interactive remote access or secure machine-to-machine remote access or communication, and remote access services shall not be limited to any single embodiment, but rather construed in breadth and scope in accordance with the recitation of the appended claims.

1. A system for secure remote access to an industrial control system using hardware based authentication, comprising:
secure user authentication;
secure interactive remote access or secure machine-to-machine remote access or communication; and
remote access services.

2. The system for secure remote access to an industrial control system of claim 1, wherein the secure user authentication comprises two-factor authentication (2FA) or three-factor authentication (3FA) based on smart cards.

3. The system for secure remote access to an industrial control system of claim 1, wherein the secure user authentication comprises possession of a smart card and knowledge of the corresponding personal identification number (PIN) and, optionally, biometrics.

4. The system for secure remote access to an industrial control system of claim 2, wherein the smart cards comprise secure element (SE) storing of credentials, cryptographic keys, and X.509 certificates.

5. The system for secure remote access to an industrial control system of claim 2, wherein the smart cards for an administrator, a supervisor, and an end-user have different capabilities.

6. The system for secure remote access to an industrial control system of claim 1, wherein the secure interactive remote access comprises a managed remote-access appliance (RAA), comprising a virtual machine and software.

7. The system for secure remote access to an industrial control system of claim 6, wherein the managed remote-access appliance (RAA) can only be used with a smart card credential.

8. The system for secure remote access to an industrial control system of claim 1, wherein the remote access services comprises technical cyber-security control services that automate security policy and processes for user and token lifecycle management, software configuration management, access control and authorization using layered security, and audit trails of remote access.

9. The system for secure remote access to an industrial control system of claim 1, wherein the remote access services comprises management of users, smart card tokens, and remote-access appliance (RAA) state.

10. The system for secure remote access to an industrial control system of claim 1, wherein the remote access services comprise management of remote access authorizations and policy, and layered-security controls.

11. A method for secure remote access to an industrial control system, comprising the steps of:
providing a system for secure remote access to an industrial control system using hardware based authentication;
performing secure user authentication;
providing secure interactive remote access or secure machine-to-machine remote access or communication; and
providing remote access services.

12. The method for secure remote access to an industrial control system of claim 11, wherein the step of performing secure user authentication comprises providing two-factor authentication (2FA) or three-factor authentication (3FA) requiring possession of a smart card and a personal identification number (PIN) and, optionally, biometrics.

13. The method for secure remote access to an industrial control system of claim 11, wherein the step of providing secure interactive remote access comprises authorizing a smart card PIN with a remote access appliance (RAA) comprising a virtual machine and software.

14. The method for secure remote access to an industrial control system of claim 11, wherein the step of providing remote access services comprises providing account management of the roles of an administrator, a supervisor, and at least one end-user.

15. The method for secure remote access to an industrial control system of claim 11, wherein the step of providing remote access services comprises providing non-repudiation by using the RSA cryptosystem digital signature scheme.

16. The method for secure remote access to an industrial control system of claim 11, wherein the step of providing remote access services comprises providing auditable records by securely storing all transaction events in a database.

17. The method for secure remote access to an industrial control system of claim 11, wherein the step of providing remote access services comprises limiting the number of incorrect PIN entries.

18. The method for secure remote access to an industrial control system of claim 11, wherein the step of providing remote access services comprises sending system use notifications to a supervisor informing the supervisor of end-user login, logout and workstation access of the end-user.

19. The method for secure remote access to an industrial control system of claim 11, wherein the step of providing remote access services comprises requiring a supervisor to authorize user access to a workstation.

20. The method for secure remote access to an industrial control system of claim 11, wherein the step of providing remote access services comprises providing identification and authorization processes.
